(19) United States
(12) Patent Application Publication
(10) Pub. No.: US 2025/0310473 A1
(43) Pub. Date: Oct. 2, 2025

(54) ELECTRONIC DEVICE AND OPERATING METHOD THEREOF

(71) Applicant: Samsung Electronics Co., Ltd., Suwon-si (KR)

(72) Inventors: Minsang KIM, Suwon-si (KR); Seungbeom EO, Suwon-si (KR); Sangeun Lee, Suwon-si (KR); Seonyul Lee, Suwon-si (KR); Taehwa Lee, Suwon-si (KR)

(73) Assignee: Samsung Electronics Co., Ltd., Suwon-si (KR)

(21) Appl. No.: 19/175,644

(22) Filed: Apr. 10, 2025

Related U.S. Application Data
(63) Continuation of application No. PCT/KR2025/004238, filed on Apr. 1, 2025.

(30) Foreign Application Priority Data
Apr. 2, 2024 (KR) 10-2024-0044788

(51) Int. Cl. H04N 7/01; H04N 21/443; H04N 21/485

(52) U.S. Cl. CPC H04N 7/0127; H04N 21/4436; H04N 21/485

(57) ABSTRACT

An electronic device includes: a frame rate conversion (FRC) circuit configured to perform image quality processing and FRC; memory storing one or more instructions; and at least one processor configured to execute the one or more instructions to: identify whether a picture adjustment mode is enabled or disabled, based on a quick media switching (QMS) mode being enabled; determine whether to bypass the FRC circuit, based on whether the picture adjustment mode is enabled or disabled; and based on determining whether to bypass the FRC circuit, perform control to process an input image based on the FRC circuit or based on bypassing the FRC circuit.

### CROSS-REFERENCE TO RELATED APPLICATION(S)

This application is a continuation of International Application No. PCT/KR2025/004238, filed on Apr. 1, 2025, in the Korean Intellectual Property Receiving Office, which is based on and claims priority to Korean Patent Application No. 10-2024-0044788, filed on Apr. 2, 2024, in the Korean Intellectual Property Office, the disclosures of which are incorporated by reference herein in their entireties.

### BACKGROUND

### 1. Field

This disclosure relates to an electronic device and an operating method of the electronic device. Particularly, this disclosure relates to an electronic device performing image processing and an operating method of the electronic device.

### 2. Description of Related Art

A sink device such as a television (TV) or a beam projector and a source device such as a set-top box may be connected to each other to provide consumers with comfortable environments for various purposes.

Various new high-definition multimedia interface (HDMI) functions using a variable refresh rate (VRR) have been recently released. Among them, gaming-VRR technology optimized for games and QMS-VRR technology for movie viewing provide consumers with various experiences. QMS is an abbreviation of “quick media switching” and refers to an HDMI function proposed to eliminate a blackout that occurs when switching between pieces of content with the same resolution but with different scan rates (frame rates). In the related art, even when only the frame rate changes, an unintended blackout occurs, thus causing inconvenience and degraded immersion of users. QMS-VRR may provide consumers with better viewing experiences by seamlessly switching between screens without a blackout when the frame rate changes.

### SUMMARY

Provided are an electronic device, an operating method of the electronic device, and a non-transitory computer-readable recording medium, which may enable picture adjustment according to a user's selection even in a quick media switching (QMS) mode in providing images through an electronic device.

Additional aspects will be set forth in part in the description which follows and, in part, will be apparent from the description, or may be learned by practice of the presented embodiments.

According to an aspect of the disclosure, an electronic device may include: a frame rate conversion (FRC) circuit configured to perform image quality processing and FRC; memory storing one or more instructions; and at least one processor configured to execute the one or more instructions.

According to an aspect of the disclosure, the instructions, when executed by the at least one processor individually or collectively, may cause the electronic device to identify whether a picture adjustment mode is enabled or disabled, based on a quick media switching (QMS) mode being enabled.

According to an aspect of the disclosure, the instructions, when executed by the at least one processor individually or collectively, may cause the electronic device to determine whether to bypass the FRC circuit, based on whether the picture adjustment mode is enabled or disabled.

According to an aspect of the disclosure, the instructions, when executed by the at least one processor individually or collectively, may cause the electronic device to based on determining whether to bypass the FRC circuit, perform control to process an input image based on the FRC circuit or based on bypassing the FRC circuit.

According to an aspect of the disclosure, an operating method of an electronic device, may include identifying whether a picture adjustment mode is enabled or disabled, based on a quick media switching (QMS) mode being enabled.

According to an aspect of the disclosure, an operating method of an electronic device, may include determining whether to bypass a frame rate conversion (FRC) circuit for performing image quality processing and FRC, based on whether the picture adjustment mode is enabled or disabled.

According to an aspect of the disclosure, an operating method of an electronic device, may include based on determining whether to bypass the FRC circuit, performing control to process an input image based on the FRC circuit or based on bypassing the FRC circuit.

According to an aspect of the disclosure, a non-transitory computer-readable recording medium storing one or more instructions which, when executed by one or more processors of an electronic device, cause the electronic device to: identify whether a picture adjustment mode is enabled or disabled, based on a quick media switching (QMS) mode being enabled; determine whether to bypass a frame rate conversion (FRC) circuit, based on the picture adjustment mode is enabled or disabled; and based on determining whether to bypass the FRC circuit, perform control to process an input image based on the FRC circuit, or based on bypassing the FRC circuit.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 illustrates an example of a system including an electronic device and a source device, according to one or more embodiments of the disclosure;

FIG. 2 illustrates an example of a block diagram of an electronic device, according to an embodiment of the disclosure;

FIG. 3 illustrates a block diagram of an electronic device, according to an embodiment of the disclosure;

FIG. 4 illustrates an example of operation modes that may be processed by an electronic device, according to an embodiment of the disclosure;

FIG. 5 illustrates an example of a flowchart of an operating method of an electronic device, according to an embodiment of the disclosure;

FIG. 6 illustrates an example of a flowchart of an operating method of an electronic device, according to an embodiment of the disclosure;

FIG. 7 illustrates an example of a graphical user interface for setting a quick media switching (QMS) mode, according to an embodiment of the disclosure;

FIG. 8 illustrates an example of a graphical user interface for setting an energy saving mode, according to an embodiment of the disclosure; and

FIG. 9 illustrates an example of a video timing extended metadata (VTEM) packet, according to an embodiment of the disclosure.

### DETAILED DESCRIPTION

Hereinafter, an embodiment of the disclosure will be described in detail with reference to the accompanying drawings so that those of ordinary skill in the art may easily implement the embodiment of the disclosure. However, the disclosure may be embodied in many different forms and should not be construed as being limited to the embodiment set forth herein. Also, portions irrelevant to the description of the disclosure will be omitted in the drawings for a clear description of the disclosure, and like reference numerals will denote like elements throughout the specification. Also, throughout the drawings, like reference numerals denote like elements.

Throughout the disclosure, when an element is referred to as being “connected” to another element, it may be “directly connected” to the other element or may be “electrically connected” to the other element with one or more intervening elements therebetween. Also, when a part “includes” “comprises”, or “has” a component, unless there is a particular description contrary thereto, the part may further include other components, not excluding the other components.

The phrases “in some embodiments” or “in an embodiment” appearing in various places herein may not necessarily all refer to the same embodiment.

Some embodiments may be represented by functional block configurations and various processing operations. Some or all of these functional blocks may be implemented by any number of hardware and/or software components that execute particular functions. For example, the functional blocks of the disclosure may be implemented by one or more processors or microprocessors or may be implemented by circuit components for an intended function. Also, for example, the functional blocks of the disclosure may be implemented in various programming or scripting languages. The functional blocks may be implemented as an algorithm executed in one or more processors. Also, the disclosure may employ the related art for electronic environment setting, signal processing, and/or data processing. Terms such as modules and components may be broadly used and are not limited to mechanical and physical components.

Also, the connection lines or connection members between the elements illustrated in the drawings are merely examples of functional connections and/or physical or logical connections. In an implementation of an embodiment, the connections between elements may be represented by various functional connections, physical connections, or logical connections that are replaceable or added.

Also, the expression “at least one of A, B, and C” may refer to any one of “A”, “B”, “C”, “A and B”, “A and C”, “B and C”, and “A, B, and C”. The term “or” includes any number of one or more of the associated listed items.

In an embodiment of the disclosure, an electronic device may refer to any electronic device that may receive content from a source device and display a screen corresponding thereto. Here, the content may be game, lecture, movie, or home training service content, or the like.

For example, the electronic device according to an embodiment of the disclosure may be any electronic device that may selectively display at least one piece of content, and may be in various forms such as a television (TV), a smart TV, a digital broadcasting terminal, a tablet personal computer (PC), a smart phone, a mobile phone, a computer, and a notebook computer. Also, the electronic device may be mobile or portable as well as stationary.

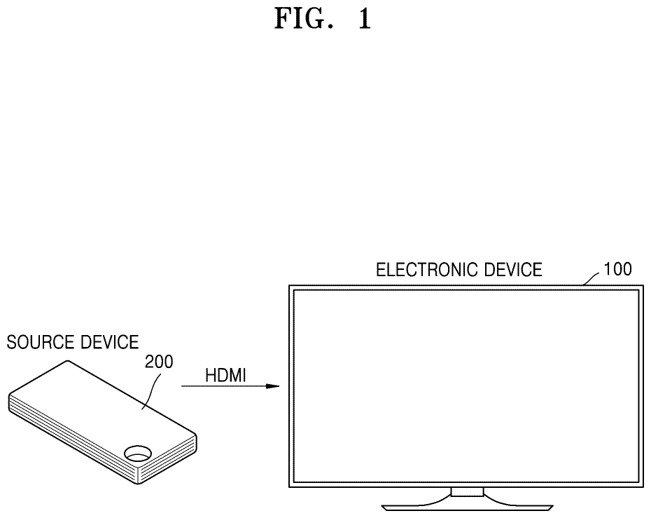

FIG. 1 illustrates an example of a system including an electronic device and a source device according to some embodiments of the disclosure.

Referring to FIG. 1, the system may include an electronic device 100 and a source device 200.

The source device 200 may provide content such as video or audio to the electronic device 100. The source device 200 may include, for example, various types of electronic devices, such as a set-top box, a digital versatile disk (DVD) player, a Blu-ray disc player, a personal computer (PC), and a game console, that may provide content to the electronic device 100. The source device 200 may be referred to as a source device in terms of providing content and may also be referred to as a host device, a content providing device, an electronic device, a computing device, or the like.

The electronic device 100 may output or display content received from the source device 200. The electronic device 100 may include, for example, various types of electronic devices, such as a network TV, a smart TV, an Internet TV, a Web TV, an Internet protocol TV (IPTV), and a PC, that may receive and display content. The electronic device 100 may be referred to as a display device in terms of receiving and displaying content and may also be referred to as a content receiving device, a sink device, an electronic device, a computing device, or the like.

The source device 200 and the electronic device 100 may be connected to each other through various connection units to perform content transmission/reception. The various connection units may include, for example, a cable, and the source device 200 and the electronic device 100 may include one or more ports for cable connection. The one or more ports may include, for example, a digital input interface such as a high-definition multimedia interface (HDMI) port, a display port, or a Type-C. For example, each of the source device 200 and the electronic device 100 may include an HDMI port and may perform communication through the HDMI port. When the source device 200 provides content to the electronic device 100, the source device 200 may first receive extended display identification data (EDID) information provided by the electronic device 100, generate content in a format corresponding to the received EDID information, and provide the content to the electronic device 100. The EDID information may be information defining the display performance or display capability of the electronic device 100 for displaying content and may include, for example, timing information and resolution information. Thus, the source device 200 may generate a format of content to be transmitted to the electronic device 100 based on the timing information and the resolution information defined in the EDID information provided by the electronic device 100 and provide the format of the content to the electronic device 100. For example, when the EDID information provided by the electronic device 100 defines processing high resolution, the source device 200 may provide high-resolution content to the electronic device 100, and when the EDID information provided by the electronic device 100 defines processing low resolution, the source device 200 may provide low-resolution content to the electronic device 100. Through the EDID information, the source device 200 may provide the electronic device 100 with content in a format suitable for the display performance of the electronic device 100.

Quick media switching (QMS) is a function introduced as a portion of the HDMI 2.1 standard and may be a technology to improve the switching between pieces of media content, such as making the switching more quick and smooth. QMS for movies and videos based on HDMI 2.1 may eliminate a blackout period that occurs when an HDMI source device switches between video modes by using an HDMI variable refresh rate (HDMI VRR) mechanism. QMS may immediately switch between different frame rates when the resolution is maintained and only the frame rate is changed. For example, when viewing trailers in streaming services or Blu-rays, some of them may be 24 Hz, 50 Hz, or 60 Hz. Before HDMI 2.1 and QMS, whenever trailers with different frame rates were selected, frames would be repeated in a particular progression order to compensate for a frame rate difference, which may cause a motion jitter. Also, whenever the frame rate was changed, the clock of the entire system would be changed and resynchronized, which may cause a (audio/video) A/V blackout. QMS may eliminate a blackout by using the VRR technology.

Various embodiments of the disclosure may eliminate a blackout by using the VRR technology in the QMS mode, but this may cause a certain degree of image quality degradation. Thus, it may be desirable to allow the user to adjust the image quality according to the user's selection even in the QMS mode.

According to an embodiment of the disclosure, the electronic device 100 may identify whether a QMS mode is set and identify whether a picture adjustment mode is enabled or disabled, according to identification that the QMS mode is set. The electronic device 100 may determine whether to bypass a frame rate conversion (FRC) circuit based on whether the picture adjustment mode is enabled or disabled and perform, according to the determination, control to process an input image based on the FRC circuit or bypass the FRC circuit.

According to an embodiment of the disclosure, the electronic device 100 may perform control to bypass the FRC circuit in processing the input image, according to identification that the picture adjustment mode is disabled, and control the FRC circuit to process the input image for FRC, according to identification that the picture adjustment mode is enabled.

According to an embodiment of the disclosure, the electronic device 100 may perform control such that the input image is frame-rate-converted based on a display processor, according to identification that the picture adjustment mode is disabled.

According to an embodiment of the disclosure, the electronic device 100 may perform control such that a backlight unit (BLU) operates at a maximum frequency, according to identification that the picture adjustment mode is disabled, and perform control such that the BLU operates at a frequency corresponding to an output frequency of the FRC circuit, according to identification that the picture adjustment mode is enabled.

According to an embodiment of the disclosure, the electronic device 100 may provide a graphical user interface for setting the QMS mode, and identify whether the QMS mode is set, based on a value set through the graphical user interface.

According to an embodiment of the disclosure, the electronic device 100 may provide a graphical user interface for enabling or disabling the picture adjustment mode, and identify whether the picture adjustment mode is enabled or disabled, based on a value set through the graphical user interface.

According to an embodiment of the disclosure, the electronic device 100 may identify whether an energy saving mode is enabled, according to identification that the QMS mode and the picture adjustment mode are enabled, identify a frame rate of a video signal currently transmitted, according to identification that the energy saving mode is enabled, and perform, based on the frame rate, control such that the BLU operates at an operation frequency based on the frame rate.

According to an embodiment of the disclosure, the electronic device 100 may identify the frame rate of the video signal with reference to a next target frame rate (Next TFR) of a video timing extended metadata (VTEM) packet according to an HDMI protocol.

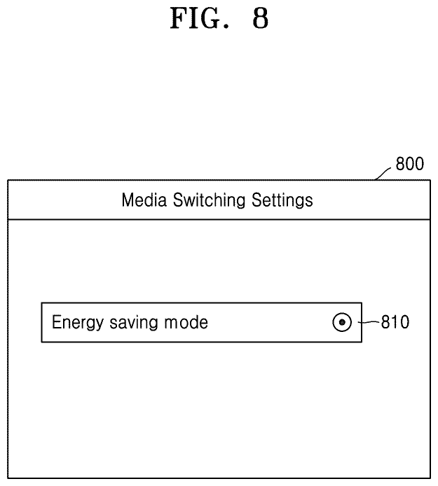

According to an embodiment of the disclosure, the electronic device 100 may provide a graphical user interface 800 for enabling the energy saving mode through an energy saving mode item 810 as illustrated in FIG. 8, and identify whether the energy saving mode is enabled, based on a value set through the graphical user interface.

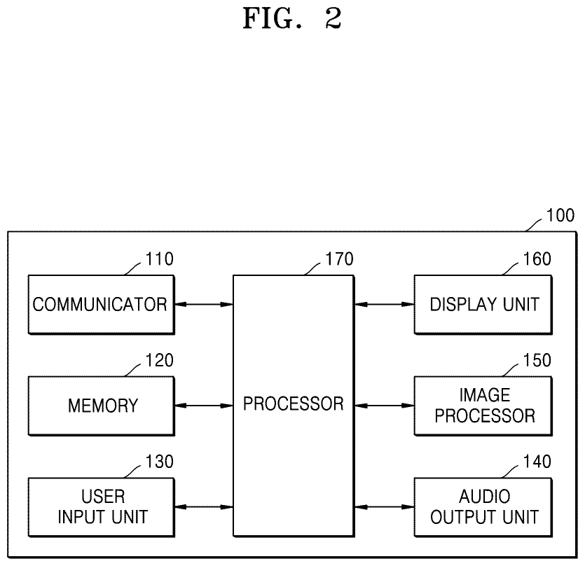

FIG. 2 illustrates an example of a block diagram of an electronic device according to an embodiment of the disclosure.

Referring to FIG. 2, the electronic device 100 may include a communicator 110, a memory 120, a user input unit 130, an audio output unit 140, an image processor 150, a display unit 160, and a processor 170.

The electronic device 100 may output or display content received from the source device 200. The electronic device 100 may include, for example, various types of electronic devices, such as a network TV, a smart TV, an Internet TV, a Web TV, an IPTV, and a PC, that may receive and display content. The electronic device 100 may be referred to as a display device in terms of receiving and displaying content and may also be referred to as a content receiving device, a sink device, a computing device, or the like.

The electronic device 100 may be connected to the source device 200 through a wired or wireless communication network.

The electronic device 100 and the source device 200 may perform content transmission/reception by being connected through a wired connection unit for forming a wired network. For example, the wired connection unit may include a cable, and each of the electronic device 100 and the source device 200 may include one or more ports for cable connection. The one or more ports may include, for example, a digital input interface such as an HDMI port, a display port, or a Type-C.

The electronic device 100 and the source device 200 may perform content transmission/reception by being connected through a wireless connection unit for forming a wireless network. For example, the wireless connection unit may include a wireless HDMI communication module, and each of the electronic device 100 and the source device 200 may include a wireless HDMI communication module. In an embodiment, the wireless connection unit may include at least one communication module that performs communication according to a communication standard, such as Bluetooth, WiFi, Bluetooth Low Energy (BLE), Near Field Communication/Radio Frequency Identification (NFC/RFID), WiFi Direct, Ultra-Wideband (UWB), ZigBee, Internet, 3G, 4G, 5G, and/or 6G.

The communicator 110 may perform communication with at least one external device. Here, ‘communication’ may refer to an operation of transmitting and/or receiving data, signals, requests, and/or commands.

The communicator 110 may perform wired or wireless communication with at least one external device. For example, the communicator 110 may include at least one of a communication module, a communication circuit, a communication device, an input/output port, or an input/output plug for performing wired or wireless communication with at least one external device.

For example, the communicator 110 may include at least one wireless communication module, wireless communication circuit, or wireless communication device for performing wireless communication with at least one external device.

For example, the communicator 110 may include a short-range communication module such as an infrared (IR) communication module that may receive a control command from a remote controller located at a short distance, for example, from an input device. In this case, the communicator 110 may receive a control signal from the remote controller.

In an embodiment, the communicator 110 may include at least one communication module performing communication according to a communication standard such as Bluetooth, WiFi, BLE, NFC/RFID, WiFi Direct, UWB, or ZigBee. The communicator 110 may further include a communication module performing communication with a server for supporting long-range communication according to the long-range communication standard.

For example, the communicator 110 may include a communication module performing communication through a network for Internet communication. The communicator 110 may include a communication module performing communication through a communication network conforming to the communication standard such as 3G, 4G, 5G, and/or 6G.

In an embodiment, the communicator 110 may include at least one port for connecting with an external device through a wired cable in order to communicate with the external device in a wired manner. For example, the communicator 110 may include at least one of an HDMI port, a component jack, a PC port, or a universal serial bus (USB) port. Accordingly, the communicator 110 may perform communication with the external device connected by wire through the at least one port. Here, the port may refer to a physical device component that may be used to connect or insert a cable, a communication line, a plug, or the like.

As described above, the communicator 110 may include at least one support element for supporting communication between the electronic device 100 and the external device. Here, the at least one support element may include the communication module, the communication circuit, the communication device, the port for data input/output, the cable port for data input/output, and/or the plug for data input/output described above. For example, the at least one support element included in the communicator 110 may include an Ethernet communication module, a WiFi communication module, a Bluetooth communication module, an IR communication module, a USB port, a tuner (or a broadcast receiver), an HDMI port, a display port (DP), and/or a digital visual interface (DVI) port.

The memory 120 may store at least one instruction, data, information, and/or an application. For example, the memory 120 may store at least one instruction executed by the processor 170. For example, the memory 120 may store at least one program executed by the processor 170. For example, the memory 120 may store an application for providing a specified service.

The memory 120 may include at least one type of storage medium from among flash memory type, hard disk type, multimedia card micro type, card type memory (e.g., SD or XD memory), random access memory (RAM), static random access memory (SRAM), read only memory (ROM), electronically erasable programmable read only memory (EEPROM), programmable read only memory (PROM), magnetic memory, magnetic disk, or optical disk.

According to an embodiment of the disclosure, the memory 120 may store a flag indicating whether the QMS mode is enabled, a flag indicating whether the picture adjustment mode is enabled, and a flag indicating whether the energy saving mode is enabled.

The user input unit 130 may transmit various preset control commands or information to the processor 170 or the image processor 150 according to the user's operation or input. The user input unit 130 may transmit, to the processor 170 or the image processor 150, various events generated by the user's operation according to the user's intention. The user input unit 130 may be implemented in various forms according to information input methods. For example, the user input unit 130 may include a user interface environment installed in the electronic device 100, such as a button installed on the outside of the electronic device 100, a touch screen installed on the display unit 160, a microphone into which the user's speech is input, and/or a camera for photographing or detecting an environment outside the electronic device 100. The remote controller may also be considered as a component of the user interface environment. However, because the remote controller is a component separate from the main body of the electronic device 100, the remote controller may transmit a control signal to the electronic device 100 through a separate control signal receiver arranged in the main body of the electronic device 100.

According to an embodiment of the disclosure, the user input unit 130 may receive a user input including information indicating whether the QMS mode is enabled, information indicating whether the picture adjustment mode is enabled, or information indicating whether the energy saving mode is enabled.

The audio output unit 140 may output an audio signal.

The image processor 150 may perform preprocessing or postprocessing of a received image. For example, the image processor 150 may receive an image in the form of a modulated signal and perform preprocessing for demodulating the received signal. Also, the image processor 150 may demultiplex the demodulated signal into image signals. In addition to the basic image processing described above, the image processor 150 may also perform various postprocessing such as noise processing or an FRC. Here, the frame rate may refer to a rate at which consecutive images are reproduced. The electronic device 100 may output a suitable number of image frames per second by using human visual characteristics, and FRC may represent postprocessing for changing or adjusting the rate of output image frames. For example, when the type of a received image is a movie-like image, performing FRC may help to improve the picture. However, in the case of a game image requiring immediate conversion by the user's input, performing FRC may cause an image judder or blur. Thus, it may be desirable to determine whether to process FRC, depending on the environment of an image.

According to an embodiment of the disclosure, under control by the processor 170, the image processor 150 may process or bypass FRC depending on whether the QMS mode is enabled, whether the picture adjustment mode is enabled, and whether the energy saving mode is enabled.

The display unit 160 may display image data processed by the image processor 150. The implementation type of the display unit 160 is not limited, and the display unit 160 may include a display panel with a light-receiving structure such as a liquid crystal type or with a self-luminous structure such as an OLED type. The display unit 160 may further include additional components in addition to the display panel, depending on the implementation type of the display panel. For example, in the case of a liquid crystal type, the display unit 160 may include a liquid crystal display panel, a backlight unit for supplying light to the liquid crystal display panel, and a panel driving substrate for driving the liquid crystal display panel.

According to an embodiment of the disclosure, under control by the processor 170, the display unit 160 may vary the operation frequency of the BLU depending on whether the QMS mode is enabled, whether the picture adjustment mode is enabled, and whether the energy saving mode is enabled.

The processor 170 may be a component that performs a central operation for operation of the components in the electronic device 100 and may be provided as a processor that basically performs a central function for data interpretation and operation. The processor 170 may internally include a processor register storing instructions to be processed, an arithmetic logic unit (ALU) performing comparison, determination, and operation, a control process unit (CPU) internally controlling the interpretation and correct execution of instructions, an internal bus, a cache, and/or the like. The processor 170 may determine the type of the image by using an initial image frame of the received image.

The processor 170 may execute at least one instruction to perform control such that an intended operation is performed. Here, the at least one instruction may be stored in an internal memory included in the processor 170 or in the memory 120 included in the electronic device 100 separately from the processor 170.

The processor 170 may execute the at least one instruction to control at least one component included in the electronic device 100 such that an intended operation is performed. Thus, although a case where the processor 170 performs certain operations is described as an example, the processor 170 may control at least one component included in the electronic device 100 such that certain operations are performed.

Although a case where the processor 170 includes one processor has been described and illustrated as an example, the processor 170 may include a plurality of processors.

For example, the processor 170 may include a random access memory (RAM) that stores signals or data input from the outside of the electronic device 100 or is used as a storage area corresponding to various operations performed by the electronic device 100, a read-only memory (ROM) that stores a control program for controlling the electronic device 100, an application for providing a certain function or service, and/or a plurality of instructions, and at least one processor. The processor 170 may include a graphic processor (a graphic processing unit (GPU)) for graphic processing corresponding to video. The processor may be implemented as a system-on-chip (SoC) including a combination of a core and a GPU. The processor 170 may include a single core or a multi-core. For example, the processor 170 may include a dual core, a triple core, a quad core, a hexa core, an octa core, a deca core, a dodeca core, a hexadecimal core, and/or the like.

In an embodiment of the disclosure, the processor 170 may store one or more instructions in an internal memory thereof and execute the one or more instructions stored in the internal memory to perform control such that operations of the electronic device 100 are performed. That is, the processor 170 may perform a certain operation by executing at least one instruction or program stored in the internal memory of the processor 170 or in the memory 120.

According to an embodiment of the disclosure, by executing the one or more instructions stored in the memory 120, the processor 170 may identify whether a QMS mode is set.

According to an embodiment of the disclosure, by executing the one or more instructions stored in the memory 120, the processor 170 may identify whether a picture adjustment mode is enabled or disabled in the QMS mode.

According to an embodiment of the disclosure, by executing the one or more instructions stored in the memory 120, the processor 170 may determine whether to bypass the FRC circuit based on whether the picture adjustment mode is enabled or disabled.

According to an embodiment of the disclosure, by executing the one or more instructions stored in the memory 120, the processor 170 may perform, according to the determination, control to process an input image by the FRC circuit or bypass the FRC circuit in processing the input image.

According to an embodiment of the disclosure, by executing the one or more instructions stored in the memory 120, the processor 170 may perform control to bypass the FRC circuit in processing the input image, according to identification that the picture adjustment mode is disabled, and perform control to process the input image by the FRC circuit, according to identification that the picture adjustment mode is enabled.

According to an embodiment of the disclosure, by executing the one or more instructions stored in the memory 120, the processor 170 may perform control such that the input image is FRC-processed by the display processor, according to identification that the picture adjustment mode is disabled.

According to an embodiment of the disclosure, by executing the one or more instructions stored in the memory 120, the processor 170 may perform control such that the

BLU operates at a maximum frequency, according to identification that the picture adjustment mode is disabled, and perform control such that the BLU operates at a frequency corresponding to an output frequency of the FRC circuit, according to identification that the picture adjustment mode is enabled.

According to an embodiment of the disclosure, by executing the one or more instructions stored in the memory 120, the processor 170 may provide a graphical user interface for setting the QMS mode, and identify whether the QMS mode is set, based on a value set through the graphical user interface.

According to an embodiment of the disclosure, by executing the one or more instructions stored in the memory 120, the processor 170 may provide a graphical user interface for enabling or disabling the picture adjustment mode, and identify whether the picture adjustment mode is enabled or disabled, based on a value set through the graphical user interface.

According to an embodiment of the disclosure, by executing the one or more instructions stored in the memory 120, the processor 170 may identify whether an energy saving mode is enabled, according to identification that the QMS mode and the picture adjustment mode are enabled, identify a frame rate of a video signal currently transmitted, according to identification that the energy saving mode is enabled, and perform, based on the frame rate, control such that a BLU operates at an operation frequency based on the frame rate.

According to an embodiment of the disclosure, by executing the one or more instructions stored in the memory 120, the processor 170 may identify the frame rate of the video signal with reference to a Next TFR of a VTEM packet according to ah HDMI protocol.

According to an embodiment of the disclosure, by executing the one or more instructions stored in the memory 120, the processor 170 may provide a graphical user interface for enabling the energy saving mode, and identify whether the energy saving mode is enabled, based on a value set through the graphical user interface.

The electronic device 100 may be any type of device that includes a processor and a memory to perform a function. The electronic device 100 may be a stationary or portable device. For example, the electronic device 100 may refer to a device that includes a display to display image content, video content, game content, graphic content, and the like. The electronic device 100 may output or display an image or content received from the source device 200. The electronic device 100 may include, for example, various types of electronic devices capable of receiving and outputting content, such as TVs such as network TVs, smart TVs, Internet TVs, Web TVs, and IPTVs, computers such as desktops, laptops, and tablets, and various smart devices such as smartphones, cellular phones, game players, music players, video players, medical equipment, and home appliances. The electronic device 100 may be referred to as a display device in terms of receiving and displaying content and may also be referred to as a content receiving device, a sink device, an electronic device, a computing device, or the like.

The block diagram of the electronic device 100 illustrated in FIG. 2 may be a block diagram for an embodiment of the disclosure. Each component of the block diagram may be integrated, added, or omitted according to the specifications of the electronic device 100 that are actually implemented. For example, when necessary, two or more components may be combined into one component, or one component may be divided into two or more components. Also, a function performed in each block is to describe embodiments of the disclosure, and a particular operation or device thereof is not intended to limit the scope of the disclosure.

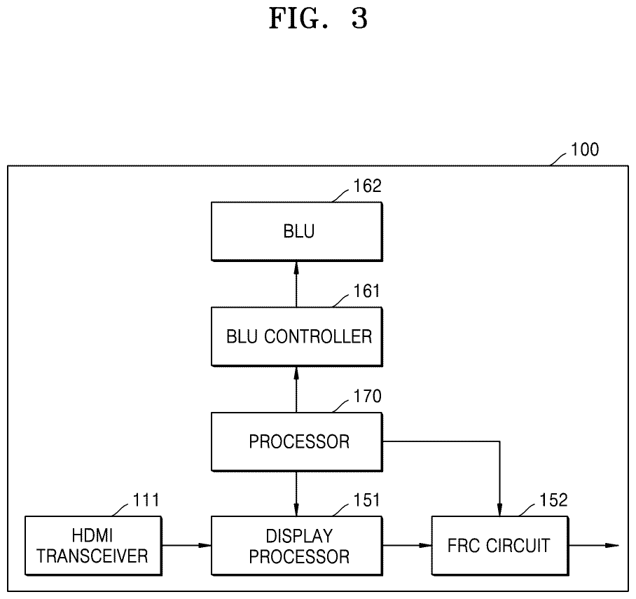

FIG. 3 illustrates a block diagram of an electronic device according to an embodiment of the disclosure.

Referring to FIG. 3, the electronic device 100 may include an HDMI transceiver 111, a processor 170, a display processor 151, an FRC circuit 152, a BLU controller 161, and a BLU 162. The HDMI transceiver 111 may be included in the communicator 110. The display processor 151 and the FRC circuit 152 may be included in the image processor 150. The BLU controller 161 and the BLU 162 may be included in the display unit 160.

The HDMI transceiver 111 may be a unit transmitting/receiving data through an HDMI and may transmit/receive data including not only audio/video data but also messages such as commands, requests, actions, and responses between devices.

According to an embodiment of the disclosure, the HDMI transceiver 111 may transmit the EDID of the electronic device 100 to the source device 200 when the source device 200 and the electronic device 100 are connected to each other.

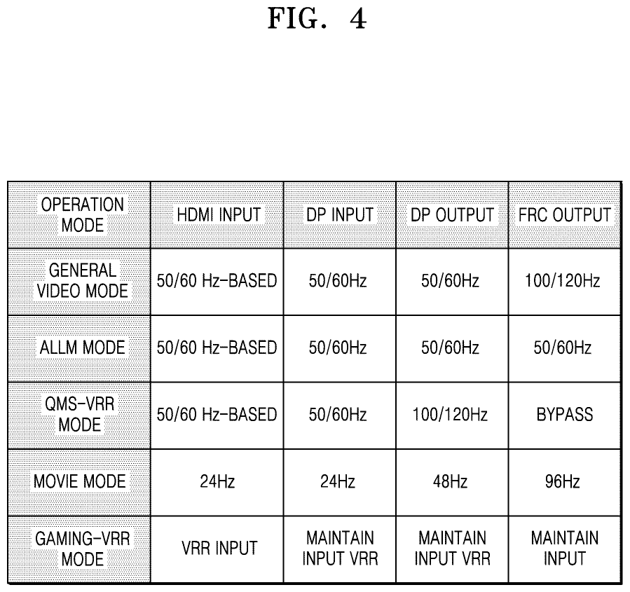

According to an embodiment of the disclosure, the HDMI transceiver 111 may receive a video signal according to the HDMI and may also detect an operation mode through a VTEM packet. The operation mode may include a general video mode, an auto low latency mode (ALLM) mode, a QMS-VRR mode, a movie mode, a gaming-VRR mode, and the like. Because the operation of the display processor 151 and the FRC circuit 152 varies depending on each operation mode, the HDMI transceiver 111 may transmit information about the detected operation mode to the processor 170 and the display processor 151. A description of each operation mode will be described in detail with reference to FIG. 4.

The display processor 151 may detect and process the resolution, color format, frame rate, and the like, of an input signal. The display processor 151 may adjust the frame rate of the input signal to match the refresh rate of the display. In this case, the display processor 151 may adjust the frame rate while maximally preserving the quality of an original input signal, such as color accuracy, sharpness, and contrast. The display processor 151 may change the frame rate into a form that may be processed by the FRC circuit 152.

The FRC circuit 152 may change the frame rate of a video. The video may include a series of still images referred to as “frames”. The frame rate may be a rate at which frames are generated and may be measured in frames per second (FPS). Thus, a 24-FPS video may mean that 24 images are displayed in one second of the video. Most movies are recorded at 24 FPS that is optimal for movie experience. TV and sports programs may use a slightly higher frame rate of 30 FPS. Video games or videos with a lot of motion details may use 60 FPS. The refresh rate may be the number of times the display changes the image, and may be measured in units of Hertz (Hz). Recent TVs may provide a refresh rate of 60 Hz, which refreshes a display image 60 times per second, or 120 Hz, which provides 120 times per second. Ideally, the frame rate speed and the refresh rate frequency should match with each other such that the transmitted content may be exactly seen on the screen. However, when there is a difference in the frame speed and the refresh frequency, the display may perform an additional operation such as FRC to properly play the content.

For example, because some TVs operate optimally at 60 Hz, they may convert a movie of 24 fps or a video of other frame rates into a 60-Hz frame rate. Converting to a higher frame rate may make a video motion smoother. Some FRC technologies may use interpolation to generate a missing frame, which may restore or improve the details of a motion that has been missed in an original video. Some TVs may operate well at a refresh rate of 60 Hz. The refresh rate may be a numerical value that indicates how many times per second a TV screen refreshes an image and may be represented in units of Hertz (Hz). A 60-Hz refresh rate may mean that the TV refreshes an image 60 times per second. When the refresh rate of the TV matches the frame rate (frames per second (FPS)) of the video content, the image may appear smoother and more natural. For example, 30-fps or 60-fps content may be smoothly played by a 60-Hz TV. For example, the 60-Hz TV may be ideal particularly when playing 60-fps content. Because each frame is displayed on the screen for exactly 1/60 seconds, the motion may appear natural and continuous. When the frame rate of the video content is different from the refresh rate of the TV, the TV may use FRC to suitably match the content to the refresh rate. For example, when playing a 24-fps movie on a 60-Hz TV, the FRC technology may suitably convert the frames to match the refresh rate of the screen.

According to an embodiment of the disclosure, the FRC circuit 152 may FRC-process data received from the display processor 151 in accordance with the operation mode and output the FRC-processed data. That is, the FRC circuit 152 may change the frame rate and perform image quality processing such that a natural screen output may be achieved according to the operation mode.

According to an embodiment of the disclosure, under control by the processor 170, the FRC circuit 152 may bypass FRC when the QMS mode is enabled and the picture adjustment mode is disabled.

According to an embodiment of the disclosure, under control by the processor 170, the FRC circuit 152 may process FRC when the QMS mode is enabled and the picture adjustment mode is enabled.

The BLU controller 161 may control the BLU according to the operation mode. The BLU controller 161 may control the BLU 162 such that the BLU operates at an operation frequency determined according to the operation mode.

According to an embodiment of the disclosure, under control by the processor 170, the BLU controller 161 may perform control such that the BLU operates at a maximum operation frequency when the QMS mode is enabled and the picture adjustment mode is disabled.

According to an embodiment of the disclosure, under control by the processor 170, the BLU controller 161 may perform control such that the BLU operates corresponding to the output frequency of the FRC circuit when the QMS mode is enabled and the picture adjustment mode is enabled.

According to an embodiment of the disclosure, under control by the processor 170, the BLU controller 161 may perform control such that the BLU operates adaptively in accordance with the frame rate of the video signal when the QMS mode is enabled, the picture adjustment mode is enabled, and the energy saving mode is enabled.

The BLU 162 may provide light necessary to display an image on a display screen. A BLU may be mainly used for a liquid crystal display (LCD) screen, and a LCD panel may require a light providing unit because the LCD panel itself does not emit light. A BLU may be located behind a display panel such as an LCD panel to provide a constant and uniform light source, and the light may pass through the LCD panel to display an image on the screen. The overall brightness of the display may be adjusted by adjusting the brightness of the BLU. The operation frequency of the BLU may mean a value indicating how fast the BLU blinks. The brightness of the display may be adjusted by adjusting the operation frequency of the BLU. When the operation frequency is high, the BLU may blink more frequently such that the screen may appear brighter, and when the operation frequency is low, the BLU may blink less frequently such that the screen may become darker. Using a high operation frequency may make the BLU blink less noticeable, improve the sharpness of a dynamic image, and reduce a motion blur. However, in general, the power consumption may increase as the operation frequency increases. The BLU operation frequency may be determined according to the design and performance of the display, generally within the range of tens to hundreds of Hertz (Hz).

The processor 170 may receive information about the operation mode from the HDMI transceiver.

According to an embodiment of the disclosure, the processor 170 may transmit a setting value corresponding to the operation mode to the display processor, the FRC circuit, and the BLU controller. How the display processor, the FRC circuit, and the BLU controller operate according to each operation mode will be described below with reference to FIG. 4.

According to an embodiment of the disclosure, the processor 170 may identify whether the QMS mode is enabled, whether the picture adjustment mode is enabled, and whether the energy saving mode is enabled, by reading a flag (e.g., a status) indicating whether the QMS mode is enabled, a flag indicating whether the picture adjustment mode is enabled, and a flag indicating whether the energy saving mode is enabled, which are stored in the memory 120.

According to an embodiment of the disclosure, when the QMS mode is not enabled, the processor 170 may perform control to maintain the previous setting of the BLU controller, the setting of the display processor, and the setting of the FRC circuit.

According to an embodiment of the disclosure, when the QMS mode is enabled and the picture adjustment mode is not enabled, that is, disabled, the processor 170 may perform control to bypass FRC processing and may control the BLU controller such that the BLU operates at a maximum frequency.

According to an embodiment of the disclosure, when the QMS mode is enabled and the picture adjustment mode is enabled, the processor 170 may control the FRC circuit to perform FRC processing and may control the BLU controller such that the BLU operates according to the output frequency of the FRC circuit.

According to an embodiment of the disclosure, when the QMS mode, the picture adjustment mode, and the energy saving mode are all enabled, the processor 170 may control the FRC circuit to perform FRC processing and may control the BLU controller such that the BLU operates corresponding to the frame rate of the video signal.

Under control by the processor 170, the BLU controller 161 may perform control such that the BLU operates at a maximum operation frequency when the QMS mode is enabled and the picture adjustment mode is disabled.

According to an embodiment of the disclosure, under control by the processor 170, the BLU controller 161 may perform control such that the BLU operates corresponding to the output frequency of the FRC circuit when the QMS mode is enabled and the picture adjustment mode is enabled.

According to an embodiment of the disclosure, under control by the processor 170, the BLU controller 161 may perform control such that the BLU operates adaptively in accordance with the frame rate of the video signal when the QMS mode is enabled, the picture adjustment mode is enabled, and the energy saving mode is enabled.

FIG. 4 illustrates an example of operation modes that may be processed by an electronic device according to an embodiment of the disclosure.

Referring to FIG. 4, the operation modes that may be processed by the electronic device 100 may include a general video mode, an ALLM mode, a QMS-VRR mode, a movie mode, and a gaming-VRR mode.

While the electronic device 100 operates in the general video mode, the electronic device 100 may receive a 50/60 Hz-based input signal as an HDMI input. The display processor 151 may receive a 50/60 Hz-based input signal and output the same as a 50/60 Hz-based output signal. The FRC circuit 152 may receive a 50/60 Hz-based input signal, adjust the same to 100/120 Hz, and output the resulting signal. In the general video mode, the FRC circuit may generate and output a smooth picture by doubling the frame rate.

While the electronic device 100 operates in the ALLM mode, the electronic device 100 may receive a 50/60 Hz-based input signal as an HDMI input. The display processor 151 may receive a 50/60 Hz-based input signal and output the same as a 50/60 Hz-based output signal. The FRC circuit 152 may receive a 50/60 Hz-based input signal and output the same without adjustment. The ALLM mode may be one of the functions introduced in the HDMI 2.1 standard, and because it focuses on providing low latency particularly when playing a game or high-speed video content, it may be configured to bypass the FRC circuit, which requires processing time, in order to minimize processing latency.

While the electronic device 100 operates in the QMS-VRR mode, the electronic device 100 may receive a 50/60 Hz-based input signal as an HDMI input. The display processor 151 may receive a 50/60 Hz-based input signal and output the same as a 100/120 Hz-based output signal. The FRC circuit 152 may receive a 100/120 Hz-based input signal and bypass the same. In the QMS-VRR mode, by bypassing the processing by the FRC circuit 152 as such, the latency due to the operation of the FRC circuit may be reduced and QMS may be enabled accordingly. Also, in order to compensate for the bypass of an FRC operation, the input signal may be sampled twice in the display processor and output to the FRC circuit 152. In the FRC circuit 152, processing time may be required because new frames are generated through interpolation between adjacent frames, whereas in the processing of doubling the input signal in the display processor 151, processing time may not be required because new frames are generated by simply duplicating the existing frames.

Also, because the processing by the FRC circuit is bypassed as such in the QMS-VRR mode, the BLU controller may be controlled to operate the BLU at a maximum operation frequency of 960 Hz in order not to miss frames to the maximum.

While the electronic device 100 operates in the movie mode, the electronic device 100 may receive a 24 Hz-based input signal as an HDMI input. The display processor 151 may receive a 24 Hz-based input signal and output the same as a 48 Hz-based output signal. The FRC circuit 152 may receive a 48 Hz-based input signal and output a 96 Hz-based signal by FRC processing.

While the electronic device 100 operates in the gaming-VRR mode, the electronic device 100 may receive an input signal of VRR as an HDMI input. The display processor 151 may output a signal by maintaining the VRR of the input signal, and the FRC circuit 152 may output a signal by maintaining the input VRR.

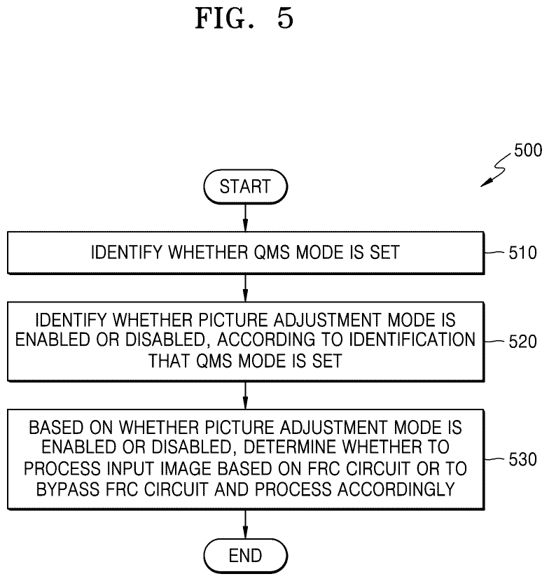

FIG. 5 illustrates an example of a flowchart of a method 500 of operating an electronic device according to an embodiment of the disclosure.

Referring to FIG. 5, in operation 510, the electronic device 100 may identify whether the QMS mode is set.

According to an embodiment of the disclosure, the electronic device 100 may determine to set the QMS mode according to its own policy, and accordingly, the electronic device 100 may include a flag for setting the QMS mode. The electronic device 100 may identify whether the QMS mode is set, based on a setting value of the flag for setting the QMS mode.

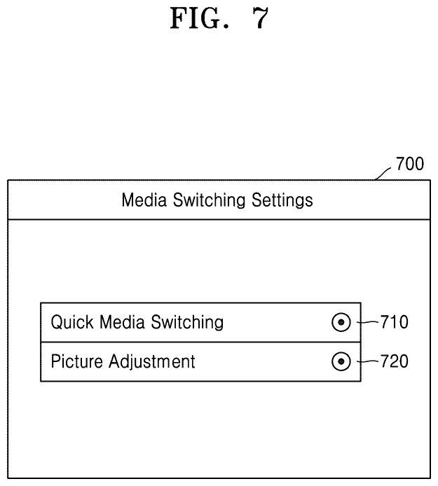

According to an embodiment of the disclosure, the electronic device 100 may provide a graphical user interface for setting the QMS mode and may set the QMS mode according to a user input received through the graphical user interface. The electronic device 100 may identify whether the QMS mode is set, based on information set as such according to the user input. For example, the electronic device 100 may provide a graphical user interface as illustrated in FIG. 7 and perform setting to enable or disable the QMS mode according to the user input received through the graphical user interface. Enabling the QMS mode may mean that the electronic device 100 may operate in the QMS mode, and disabling the QMS mode may mean that the electronic device 100 may not operate in the QMS mode.

FIG. 7 illustrates an example of a graphical user interface for setting a QMS mode according to an embodiment of the disclosure.

Referring to FIG. 7, a graphical user interface 700 for setting the QMS mode may include a QMS item 710 and a picture adjustment item 720.

The user may set the QMS mode according to a user input for making the QMS item 710 selected. Setting the QMS mode may mean that the QMS mode is enabled. The user may not set the QMS mode according to a user input for making the QMS item 710 unselected. Not setting the QMS mode may mean that the QMS mode is disabled.

The user may set the picture adjustment mode according to a user input for making the picture adjustment item 720 selected. Setting the picture adjustment mode may mean that the picture adjustment mode is enabled. The user may not set the picture adjustment mode according to a user input for making the picture adjustment item 720 unselected. Not setting the picture adjustment mode may mean that the picture adjustment mode is disabled.

Returning back to FIG. 5, in operation 520, the electronic device 100 may identify whether the picture adjustment mode is enabled or disabled, according to identification that the QMS mode is set.

According to an embodiment of the disclosure, the electronic device 100 may determine to set the picture adjustment mode according to its own policy, and accordingly, the electronic device 100 may include a flag for setting the picture adjustment mode. The electronic device 100 may identify whether the picture adjustment mode is set, based on a setting value of the flag for setting the picture adjustment mode.

According to an embodiment of the disclosure, the electronic device 100 may provide a graphical user interface for setting the picture adjustment mode and may set the picture adjustment mode according to a user input received through the graphical user interface. The electronic device 100 may identify whether the picture adjustment mode is set, based on information set as such according to the user input. For example, the electronic device 100 may provide a graphical user interface as illustrated in FIG. 7 and perform setting to enable or disable the picture adjustment mode according to the user input received through the graphical user interface. Enabling the picture adjustment mode may mean that the electronic device 100 may operate in the picture adjustment mode, and disabling the picture adjustment mode may mean that the electronic device 100 may not operate in the picture adjustment mode.

In operation 530, based on whether the picture adjustment mode is enabled or disabled, the electronic device 100 may determine whether to process an input image based on the FRC circuit or bypass the FRC circuit and may process accordingly.

According to an embodiment of the disclosure, the electronic device 100 may determine not to bypass the FRC circuit, according to determination that the picture adjustment mode is enabled. As such, by operating the FRC circuit and the BLU as in the general video mode in the case where the picture adjustment mode of the electronic device 100 is enabled, by adjusting the frames without bypassing the FRC circuit even in the case where the electronic device 100 operates in the QMS mode, the electronic device 100 may adjust the picture.

According to an embodiment of the disclosure, when the picture adjustment mode of the electronic device 100 is enabled, the electronic device 100 may control the BLU controller such that the BLU operates at an operation frequency in accordance with the frame rate output by the FRC circuit. For example, when the frame rate output by the FRC circuit is 100/120 Hz, the BLU controller may be controlled such that the operation frequency of the BLU also becomes 100/120 Hz.

According to an embodiment of the disclosure, the electronic device 100 may determine to bypass the FRC circuit, according to determination that the picture adjustment mode is disabled.

According to an embodiment of the disclosure, according to determination that the picture adjustment mode is disabled, the electronic device 100 may perform control such that the display processor performs FRC processing of the input signal instead of bypassing the FRC circuit.

According to an embodiment of the disclosure, according to determination that the picture adjustment mode is disabled, the electronic device 100 may control the BLU controller such that the BLU operates at an operation frequency, according to the maximum operation frequency. As such, in the case where the picture adjustment mode is disabled, by processing such that the display processor increases the frame rate of the input signal by a certain multiple and bypassing the FRC circuit, and by operating the BLU at the maximum operation frequency, the electronic device 100 may prevent the frames from being missed. This operation mode may be the same as the QMS-VRR mode illustrated in FIG. 4.

When the picture adjustment mode is enabled in the QMS mode, the electronic device 100 may operate in the general video mode illustrated in FIG. 4, and when the picture adjustment mode is disabled in the QMS mode, the electronic device 100 may operate in the QMS-VRR mode illustrated in FIG. 4. That is, the electronic device 100 may not operate uniformly according to the QMS-VRR mode illustrated in FIG. 4 in the case of the QMS mode, but the electronic device 100 may determine whether the picture adjustment mode is enabled even in the case of the QMS mode and may perform an operation in a little more consideration of the picture in the case where the picture adjustment mode is enabled.

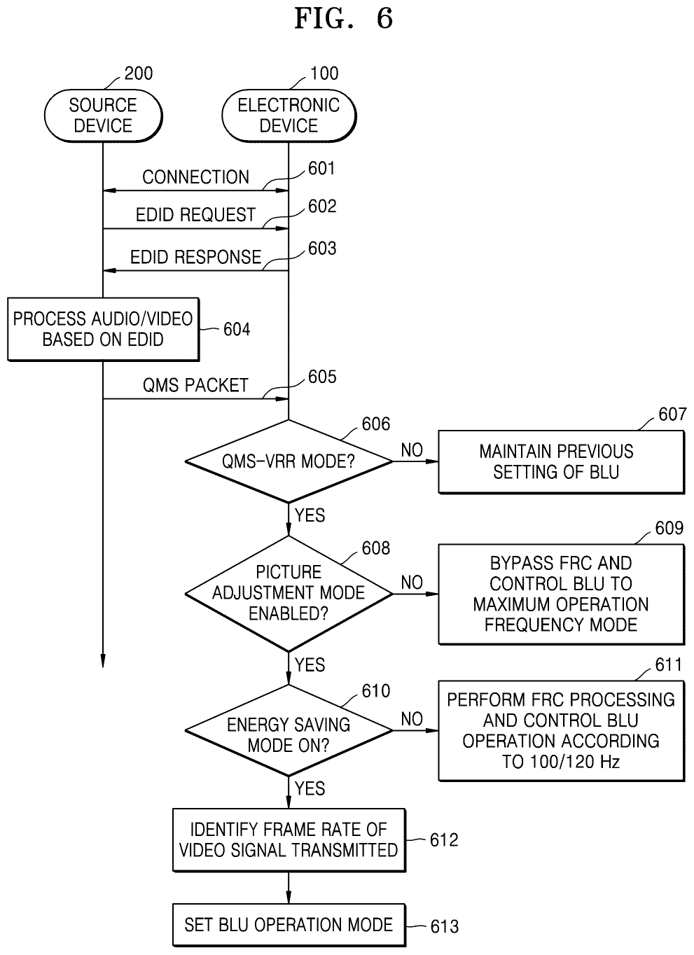

FIG. 6 illustrates an example of a flowchart of an operating method of an electronic device according to an embodiment of the disclosure.

Referring to FIG. 6, in operation 601, the electronic device 100 and the source device 200 may perform a connection operation according to an HDMI communication protocol. The user may connect an HDMI cable to the electronic device 100 and the source device 200. When the HDMI cable is connected to the source device 200 as such, the source device 200 may detect that the cable is connected through a Hot Plug Detect (HPD) signal. The HPD signal may function to notify that the source device 200 is ready to start communication with the electronic device 100.

In operation 602, the source device 200 may request the EDID of the electronic device 100.

In operation 603, in response to the EDID request of the source device 200, the electronic device 100 may provide the EDID including the function, resolution, refresh rate, color capability, and the like of the electronic device 100 to the source device 200. The EDID may represent a data structure used by the electronic device to notify its own function and capability to the source device 200.

Next, the electronic device 100 and the source device 200 may set a communication protocol between the source device 200 and the electronic device 100 through an HDMI handshake to ensure the successful establishment of the connection. When the handshake is successful, the source device 200 may transmit video and audio signals to the electronic device 100.

In operation 604, the source device 200 may analyze the EDID received from the electronic device 100 to determine the optimal video and audio format compatible with the electronic device 100. For example, the source device 200 may determine the resolution, color space, refresh rate, audio format, and the like of the video.

HDMI may be a digital interface technology for simultaneously transmitting audio and video between a source and a receiver, and HDMI has evolved in terms of supportable audio-video functions from the launch of HDMI 1.0 in 2002 to the release of HDMI 2.1a in 2022. HDMI 2.1 may support higher video resolutions and higher refresh rates such as 8K 60Hz and 4K 120Hz to ensure smooth operation during game and video. This function may include VRR, QMS, ALLM, and quick frame transport (QFT).

The HDMI forum vendor-specific data block (VSDB) of the EDID based on HDMI 2.1 may include whether to support various advanced functions. For example, the VSDB may include the following information.

HDMI Version Information: VSDB may represent the version of the HDMI standard, which may be used to determine whether a sink device supports HDMI 2.1.

Advanced Function Support Information: this may include whether to support advanced functions introduced in HDMI 2.1, such as enhanced audio return channel (eARC), VRR, ALLM, QMS, QFT, and VTEM.

Resolution and Frame Rate: VSDB may include the maximum supported resolution and frame rate information.

In order to use the advanced functions of HDMI 2.1, including QMS, the source device 200 should also support the functions and an HDMI 2.1-compatible cable may be used.

In operation 605, the source device 200 may transmit a QMS packet.

The source device 200 may transmit a QMS packet to the electronic device 100 through an HDMI interface, and the electronic device 100 may receive the QMS packet from the source device 200.

In operation 606, the electronic device 100 may identify whether the QMS mode is set.

According to an embodiment of the disclosure, by checking, from the memory, a flag indicating whether the QMS mode is enabled, the electronic device 100 may determine whether the QMS mode is enabled. For example, the flag indicating the QMS mode may be set to enable the QMS mode, according to a user input indicating to enable the QMS mode item 710. For example, the flag indicating the QMS mode may be set to disable the QMS mode, according to a user input indicating to disable the QMS mode item 710.

When the QMS mode is not enabled according to the identification of operation 606, the electronic device 100 may proceed to operation 607 to maintain the previous setting of the BLU.

When the QMS mode is enabled according to the identification of operation 606, the electronic device 100 may proceed to operation 608.

In operation 608, the electronic device 100 may determine whether the picture adjustment mode is disabled. The electronic device 100 may include a flag indicating whether the picture adjustment mode is enabled or disabled and may determine whether the picture adjustment mode is disabled, by determining whether the flag indicates enable or disable. The flag indicating the picture adjustment mode may be set based on a user input. For example, the flag indicating the picture adjustment mode may be set based on a user input that is input in response to a graphical user interface 700 as illustrated in FIG. 7. For example, the flag indicating the picture adjustment mode may be set to enable the picture adjustment mode, according to a user input indicating to enable the picture adjustment mode item 720. For example, the flag indicating the picture adjustment mode may be set to disable the picture adjustment mode, according to a user input indicating to disable the picture adjustment mode item 720.

In operation 608, the electronic device 100 may determine whether the picture adjustment mode is disabled and may proceed to operation 609 when determining that the picture adjustment mode is disabled.

In operation 609, the electronic device 100 may bypass the FRC and control the BLU in the maximum frequency operation mode. That is, when determining that the picture adjustment mode is disabled, the electronic device 100 may bypass the FRC and control the BLU in the maximum frequency operation mode. Bypassing the FRC and operating the BLU in the maximum frequency operation mode may indicate operating in the QMS-VRR mode as illustrated in FIG. 4.

In operation 610, the electronic device 100 may determine whether the energy saving mode is on.

The electronic device 100 may include a flag indicating whether the energy saving mode is enabled or disabled and may determine whether the energy saving mode is disabled, by determining whether the flag indicates enable or disable. The flag indicating the energy saving mode may be set based on a user input. For example, the flag indicating the energy saving mode may be set based on a user input that is input in response to a graphical user interface 800 as illustrated in FIG. 8. For example, the flag indicating the energy saving mode may be set to enable the energy saving mode, according to a user input indicating to enable the energy saving mode item 810. For example, the flag indicating the energy saving mode may be set to disable the energy saving mode, according to a user input indicating to disable the energy saving mode item 810.

As a result of the determination in operation 610, when the energy saving mode is not on, the electronic device 100 may proceed to operation 611, and when the energy saving mode is on, the electronic device 100 may proceed to operation 612. As a result, when the picture adjustment mode is enabled, the electronic device 100 may proceed to operation 611, and when the picture adjustment mode is enabled and the energy saving mode is enabled, the electronic device 100 may proceed to operation 612.

In operation 611, the electronic device 100 may perform FRC processing and control the BLU operation according to 100/120 Hz. That is, when determining that the picture adjustment mode is enabled, the electronic device 100 may perform FRC processing and control the BLU operation according to 100/120 Hz. Performing FRC processing and controlling the BLU operation according to 100/120 Hz may indicate operating in the general video mode as illustrated in FIG. 4.

In operation 612, in order to operate in the energy saving mode, the electronic device 100 may perform control to operate the BLU according to the frame rate of the packet.

VTEM may represent a metadata format for providing additional timing information related to a digital video stream. VTEM may describe timing-related properties of video content in detail, particularly in the HDMI 2.1 standard. VTEM may provide accurate timing information of the frame, such as a frame duration, a frame rate, and other timing-related details. Thus, by using the VTEM information, the electronic device 100 may more accurately process a video signal transmitted from the source device and may particularly help to accurately adjust the timing of dynamically changing video content.

When connecting the source device and the electronic device 100 to each other based on HDMI 2.1, VTEM may be transmitted according to a particular situation and time and a particular process thereof may be as follows.

By analyzing the EDID received from the electronic device 100, the source device 200 may identify that the electronic device 100 may support HDMI 2.1 and process VTEM. In the HDMI standard, a particular field in the VSDB may include information indicating whether to process VTEM. The VSDB may represent a portion of the EDID that provides unique function and compatibility information of the HDMI interface. When identified as such, the source device 200 may include VTEM information when transmitting a video stream thereafter. For example, when the source device 200 transmits a video stream,

VTEM information may be transmitted to the electronic device 100 together with a video signal. The VTEM may describe in detail the timing, duration, frame rate, and the like of the video frame. Through this information, the electronic device may process the video stream more accurately and efficiently. For example, when the timing of the video stream transmitted by the source device is changed (e.g., a frame rate change or a resolution change), the VTEM information may be updated reflecting this change and may be transmitted back to the electronic device 100. Accordingly, the electronic device may suitably adjust the screen and display the content according to the new video timing information.

The main method for the source device to identify that the sink device may process VTEM may be to read EDID of the sink device. The EDID may be a data structure for providing the function and compatibility information of the display device and may be transmitted to the source device through an HDMI connection. A particular operation for identifying whether the VTEM may be processed may be as follows.

When an HDMI connection is established, the source device may request EDID information from the sink device, wherein the EDID information may include the function, supported resolution, frame rate, color format, audio function, and the like of the sink device. The source device may analyze the EDID information to determine which version of HDMI the electronic device supports. Because the VTEM is a portion of the HDMI 2.1 standard, the source device may identify that the electronic device supports HDMI 2.1. The EDID may include a VSDB block indicating whether an HDMI 2.1 function is supported. The source device may analyze the VSDB to determine whether the sink device may process an advanced function including the VTEM. Through this information, the source device may determine whether the sink device supports the VTEM and transmit a suitable video signal accordingly. For the sink device supporting the VTEM, the source device may use the VTEM to provide more precise video timing information, which may provide an optimized viewing experience.

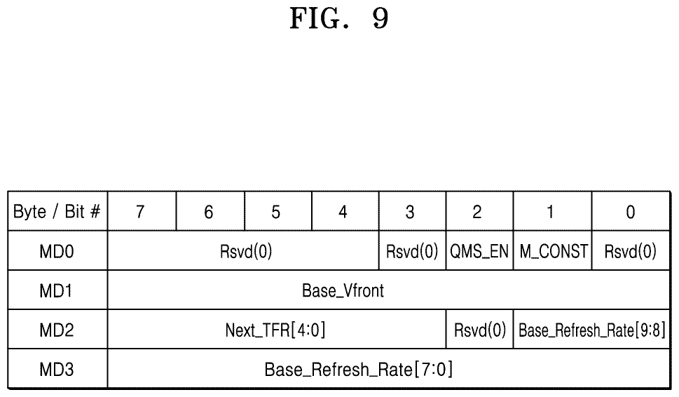

An example of the VTEM packet is illustrated in FIG. 9.

FIG. 9 illustrates an example of a VTEM packet according to an embodiment of the disclosure.

Referring to FIG. 9, QMS_EN may be a bit indicating a QMS signal and may indicate Enabled when it is 1 and indicate Disabled when it is 0.

Next_TFR: Bits that indicate the frame rate of a currently transmitted video signal.

In operation 612, the electronic device 100 may identify the frame rate of a currently transmitted video signal. The electronic device 100 may identify the frame rate of a currently transmitted video signal from a Next_TFR field of the VTEM packet.

In operation 613, the electronic device 100 may set a BLU operation mode according to the frame rate of a video signal.

For example, when the frame rate of the video signal is 24 Hz/30 Hz, the BLU may be set to operate at 30 Hz, when the frame rate of the video signal is 25 Hz/50 Hz, the BLU may be set to operate at 50 Hz, and when the frame rate of the video signal is 48 Hz/60 Hz, the BLU may be set to operate at 60 Hz.

According to an aspect of the disclosure, an electronic device may include a frame rate conversion (FRC) circuit configured to perform image quality processing and FRC; memory storing one or more instructions; and at least one processor configured to execute the one or more instructions.,

The instructions, when executed by the at least one processor individually or collectively, may cause the electronic device to: identify whether a picture adjustment mode is enabled or disabled, based on a quick media switching (QMS) mode being enabled.

The instructions, when executed by the at least one processor individually or collectively, may cause the electronic device to: determine whether to bypass the FRC circuit, based on whether the picture adjustment mode is enabled or disabled.

The instructions, when executed by the at least one processor individually or collectively, may cause the electronic device to: based on determining whether to bypass the FRC circuit, perform control to process an input image based on the FRC circuit or based on bypassing the FRC circuit.

The instructions, when executed by the at least one processor individually or collectively, may cause the electronic device to: perform control to process the input image based on bypassing the FRC circuit, based on the picture adjustment mode being disabled, and perform control to process the input image based on the FRC circuit, based on the picture adjustment mode being enabled.

The electronic device may further comprise a display processor, and the instructions, when executed by the at least one processor individually or collectively, may cause the electronic device to: perform control of the display processor to convert a frame rate of the input image, based on the picture adjustment mode being disabled.

The instructions, when executed by the at least one processor individually or collectively, may cause the electronic device to: perform control to operate a backlight unit at a maximum frequency, based on the picture adjustment mode being disabled, and perform control to operate the backlight unit at a frequency corresponding to an output frequency of the FRC circuit, based on the picture adjustment mode being enabled.

The instructions, when executed by the at least one processor individually or collectively, may cause the electronic device to: perform control to provide a graphical user interface for setting the QMS mode; and identify a status of the QMS mode, based on a value set through the graphical user interface.

The instructions, when executed by the at least one processor individually or collectively, may cause the electronic device to: perform control to provide a graphical user interface for setting the picture adjustment mode; and identify whether the picture adjustment mode is enabled or disabled, based on a value set through the graphical user interface.

The instructions, when executed by the at least one processor individually or collectively, may cause the electronic device to: identify whether an energy saving mode is enabled, based on the QMS mode and the picture adjustment mode being enabled; identify a frame rate of a video signal being transmitted, based on the energy saving mode being enabled; and perform control to operate a backlight unit at an operation frequency, based on the frame rate.

The instructions, when executed by the at least one processor individually or collectively, may cause the electronic device to: identify the frame rate of the video signal based on a next target frame rate (Next TFR) of a video timing extended metadata (VTEM) packet according to a high-definition multimedia interface (HDMI) protocol.

The instructions, when executed by the at least one processor individually or collectively, may cause the electronic device to: perform control to provide a graphical user interface for setting the energy saving mode; and identify whether the energy saving mode is enabled, based on a value set through the graphical user interface.

According to an aspect of the disclosure, an operating method of an electronic device, may comprise identifying whether a picture adjustment mode is enabled or disabled, based on a quick media switching (QMS) mode being enabled.

According to an aspect of the disclosure, the operating method may comprise determining whether to bypass a frame rate conversion (FRC) circuit for performing image quality processing and FRC, based on whether the picture adjustment mode is enabled or disabled.

According to an aspect of the disclosure, the operating method may comprise based on determining whether to bypass the FRC circuit, performing control to process an input image based on the FRC circuit or based on bypassing the FRC circuit.

According to an aspect of the disclosure, the operating method may comprise performing control to process the input image based on bypassing the FRC circuit, based on the picture adjustment mode being disabled, and performing control to process the input image based on the FRC circuit, based on the picture adjustment mode being enabled.

According to an aspect of the disclosure, the operating method may comprise performing control of a display processor to convert a frame rate of the input image, based on the picture adjustment mode being disabled.

According to an aspect of the disclosure, the operating method may comprise performing control to operate a backlight unit at a maximum frequency, based on the picture adjustment mode being disabled, and performing control to operate the backlight unit at a frequency corresponding to an output frequency of the FRC circuit, based on the picture adjustment mode being enabled.

According to an aspect of the disclosure, the operating method may comprise performing control to provide a graphical user interface for setting the QMS mode; and identifying a status of the QMS mode, based on a value set through the graphical user interface.

According to an aspect of the disclosure, the operating method may comprise providing a graphical user interface for setting the picture adjustment mode, identifying whether the picture adjustment mode is enabled or disabled, based on a value set through the graphical user interface.

According to an aspect of the disclosure, the operating method may comprise identifying whether an energy saving mode is enabled, based on the QMS mode and the picture adjustment mode being enabled; identifying a frame rate of a video signal being transmitted, based on the energy saving mode being enabled; and performing control to operate a backlight unit at an operation frequency based on the frame rate.

According to an aspect of the disclosure, the operating method may comprise identifying the frame rate of the video signal based on a next target frame rate (Next TFR) of a video timing extended metadata (VTEM) packet according to a high-definition multimedia interface (HDMI) protocol.

According to an aspect of the disclosure, the operating method may comprise providing a graphical user interface for setting the energy saving mode, identifying whether the energy saving mode is enabled, based on a value set through the graphical user interface.

According to an aspect of the disclosure, a non-transitory computer-readable recording medium storing one or more instructions which, when executed by one or more processors of an electronic device, cause the electronic device to: identify whether a picture adjustment mode is enabled or disabled, based on a quick media switching (QMS) mode being enabled; determine whether to bypass a frame rate conversion (FRC) circuit, based on the status of the picture adjustment mode; and based on determining whether to bypass the FRC circuit, perform control to process an input image based on the FRC circuit, or based on bypassing the FRC circuit.

The operating method of an electronic device according to an embodiment of the disclosure may be recorded on a computer-readable recording medium by being implemented in the form of program commands that may be performed by various computer means. Also, an embodiment of the disclosure may be a computer-readable recording medium having recorded thereon one or more programs including instructions for executing the operating method of an electronic device.

The computer-readable recording medium may include program commands, data files, and data structures either alone or in combination. The program commands recorded on the computer-readable recording medium may be those that are especially designed and configured for the disclosure, or may be those that are known and available to computer programmers of ordinary skill in the art. Examples of the computer-readable recording medium include magnetic media such as hard disks, floppy disks, or magnetic tapes, optical media such as CD-ROMs or DVDs, and magneto-optical media such as floptical disks, and hardware devices such ROMs, RAMs, or flash memories specially configured to store and execute program commands. Examples of the program commands include machine language codes that may be generated by a compiler, and high-level language codes that may be executed by a computer by using an interpreter.

Here, a machine-readable storage medium may be provided in the form of a non-transitory storage medium. Here, the term “non-transitory storage medium” may mean that the storage medium is a tangible device and does not include signals (e.g., electromagnetic waves), and may mean that data may be semipermanently or temporarily stored in the storage medium. For example, the “non-transitory storage medium” may include a buffer in which data is temporarily stored.

According to an embodiment of the disclosure, the method according to various embodiments of the disclosure described herein may be included and provided in a computer program product. The computer program product may be traded as a product between a seller and a buyer. The computer program product may be distributed in the form of a machine-readable storage medium (e.g., a compact disc read only memory (CD-ROM)) or may be distributed (e.g., downloaded or uploaded) online through an application store (e.g., Play StoreTM) or directly between two user devices (e.g., smartphones). In the case of online distribution, at least a portion of the computer program product (e.g., a downloadable app) may be at least temporarily stored or temporarily generated in a machine-readable storage medium such as a memory of a manufacturer server, a memory of an application store server, or a memory of a relay server.

According to the electronic device, the operating method of the electronic device, and the non-transitory computer-readable recording medium according to an embodiment of the disclosure, image quality processing may be flexibly adjusted according to user's settings even in the QMS mode.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. An electronic device comprising:
a frame rate conversion (FRC) circuit configured to perform image quality processing and FRC;
memory storing one or more instructions; and
at least one processor configured to execute the one or more instructions, wherein the instructions, when executed by the at least one processor individually or collectively, cause the electronic device to:
identify whether a picture adjustment mode is enabled or disabled, based on a quick media switching (QMS) mode being enabled;
determine whether to bypass the FRC circuit, based on whether the picture adjustment mode is enabled or disabled; and
based on determining whether to bypass the FRC circuit, perform control to process an input image based on the FRC circuit or based on bypassing the FRC circuit.

2. The electronic device of claim 1, wherein the instructions, when executed by the at least one processor individually or collectively, cause the electronic device to:
perform control to process the input image based on bypassing the FRC circuit, based on the picture adjustment mode being disabled, and
perform control to process the input image based on the FRC circuit, based on the picture adjustment mode being enabled.

3. The electronic device of claim 2, further comprising a display processor,
wherein the instructions, when executed by the at least one processor individually or collectively, cause the electronic device to: perform control of the display processor to convert a frame rate of the input image, based on the picture adjustment mode being disabled.

4. The electronic device of claim 1, wherein the instructions, when executed by the at least one processor individually or collectively, cause the electronic device to:
perform control to operate a backlight unit at a maximum frequency, based on the picture adjustment mode being disabled, and
perform control to operate the backlight unit at a frequency corresponding to an output frequency of the FRC circuit, based on the picture adjustment mode being enabled.

5. The electronic device of claim 1, wherein the instructions, when executed by the at least one processor individually or collectively, cause the electronic device to: perform control to provide a graphical user interface for setting the QMS mode; and
identify a status of the QMS mode, based on a value set through the graphical user interface.

6. The electronic device of claim 1, wherein the instructions, when executed by the at least one processor individually or collectively, cause the electronic device to: perform control to provide a graphical user interface for setting the picture adjustment mode; and
identify whether the picture adjustment mode is enabled or disabled, based on a value set through the graphical user interface.

7. The electronic device of claim 1, wherein the instructions, when executed by the at least one processor individually or collectively, cause the electronic device to: identify whether an energy saving mode is enabled, based on the QMS mode and the picture adjustment mode being enabled;
identify a frame rate of a video signal being transmitted, based on the energy saving mode being enabled; and
perform control to operate a backlight unit at an operation frequency, based on the frame rate.

8. The electronic device of claim 7, wherein the instructions, when executed by the at least one processor individually or collectively, cause the electronic device to: identify the frame rate of the video signal based on a next target frame rate (Next TFR) of a video timing extended metadata (VTEM) packet according to a high-definition multimedia interface (HDMI) protocol.

9. The electronic device of claim 7, wherein the instructions, when executed by the at least one processor individually or collectively, cause the electronic device to: perform control to provide a graphical user interface for setting the energy saving mode; and
identify whether the energy saving mode is enabled, based on a value set through the graphical user interface.

10. An operating method of an electronic device, the operating method comprising:
identifying whether a picture adjustment mode is enabled or disabled, based on a quick media switching (QMS) mode being enabled;
determining whether to bypass a frame rate conversion (FRC) circuit for performing image quality processing and FRC, based on whether the picture adjustment mode is enabled or disabled; and
based on determining whether to bypass the FRC circuit, performing control to process an input image based on the FRC circuit or based on bypassing the FRC circuit.

11. The operating method of claim 10, wherein the performing the control to process the input image comprises:
performing control to process the input image based on bypassing the FRC circuit, based on the picture adjustment mode being disabled, and
performing control to process the input image based on the FRC circuit, based on the picture adjustment mode being enabled.

12. The operating method of claim 11, further comprising performing control of a display processor to convert a frame rate of the input image, based on the picture adjustment mode being disabled.

13. The operating method of claim 10, further comprising:
performing control to operate a backlight unit at a maximum frequency, based on the picture adjustment mode being disabled, and
performing control to operate the backlight unit at a frequency corresponding to an output frequency of the FRC circuit, based on the picture adjustment mode being enabled.

14. The operating method of claim 10, further comprising:
performing control to provide a graphical user interface for setting the QMS mode; and
identifying a status of the QMS mode, based on a value set through the graphical user interface.

15. The operating method of claim 10, further comprising:
providing a graphical user interface for setting the picture adjustment mode, identifying whether the picture adjustment mode is enabled or disabled, based on a value set through the graphical user interface.

16. The operating method of claim 10, further comprising:
identifying whether an energy saving mode is enabled, based on the QMS mode and the picture adjustment mode being enabled;
identifying a frame rate of a video signal being transmitted, based on the energy saving mode being enabled; and
performing control to operate a backlight unit at an operation frequency based on the frame rate.

17. The operating method of claim 16, further comprising identifying the frame rate of the video signal based on a next target frame rate (Next TFR) of a video timing extended metadata (VTEM) packet according to a high-definition multimedia interface (HDMI) protocol.

18. The operating method of claim 16, further comprising:
providing a graphical user interface for setting the energy saving mode, identifying whether the energy saving mode is enabled, based on a value set through the graphical user interface.

19. A non-transitory computer-readable recording medium storing one or more instructions which, when executed by one or more processors of an electronic device, cause the electronic device to:
identify whether a picture adjustment mode is enabled or disabled, based on a quick media switching (QMS) mode being enabled;
determine whether to bypass a frame rate conversion (FRC) circuit, based on whether the picture adjustment mode is enabled or disabled; and
based on determining whether to bypass the FRC circuit, perform control to process an input image based on the FRC circuit, or based on bypassing the FRC circuit.
